(19) United States
(12) Patent Application Publication
(10) Pub. No.: US 2024/0340792 A1
(43) Pub. Date: Oct. 10, 2024

(54) TECHNIQUES FOR CONDITIONAL WAKE-UP SIGNAL MONITORING

(71) Applicant: QUALCOMM Incorporated, San Diego, CA (US)

(72) Inventors: Peter Pui Lok ANG, San Diego, CA (US); Zae Yong CHOI, San Jose, CA (US); Jafar MOHSENI, San Diego, CA (US); Alexei Yurievitch GOROKHOV, San Diego, CA (US); Aamod KHANDEKAR, San Diego, CA (US); Jittra JOOTAR, San Diego, CA (US); Surendra BOPPANA, San Diego, CA (US); Shailesh MAHESHWARI, San Diego, CA (US); Scott HOOVER, Del Mar, CA (US); Yu HU, San Diego, CA (US); Pawneet SINGH, Broomfield, CO (US); Marcelo SCHIOCCHET, San Diego, CA (US); Joshua Tennyson MACDONALD, Superior, CO (US); Chunxia LI, Beijing (CN); Matthew Heng ZHANG, Shanghai (CN); Shan QING, San Diego, CA (US); Hua XU, Shanghai (CN); Xuqiang ZHANG, Beijing (CN); Liang ZHU, Shanghai (CN); Hui LIU, Shanghai (CN); Lingchong GAO, Beijing (CN)

(21) Appl. No.: 18/577,897

(22) PCT Filed: May 18, 2022
(86) PCT No.: PCT/CN2022/093526

§ 371 Date: Jan. 9, 2024

Related U.S. Application Data
(60) Provisional application No. 63/261,081, filed on Sep. 10, 2021.

(51) Int. Cl. H04W 52/02; H04B 7/06; H04W 72/231; H04W 76/28

(52) U.S. Cl. CPC H04W 52/0235; H04B 7/0626; H04W 72/231; H04W 76/28

(57) ABSTRACT

Various aspects of the present disclosure generally relate to wireless communication. In some aspects, a user equipment (UE) may receive, from a base station, configuration information indicating a wake-up signal (WUS) configuration associated with a discontinuous reception (DRX) cycle, wherein the WU'S configuration indicates one or more WUS occasions. The UE may identify one or more conditions. The UE may refrain from monitoring at least one WUS occasion, from the one or more WUS occasions, based at least in part on the identification of the one or more conditions. The UE may monitor one or more resources during an on duration associated with the DRX cycle. Numerous other aspects are described.

### CROSS-REFERENCE TO RELATED APPLICATION

This Patent application claims priority to U.S. Provisional Patent Application No. 63/261,081, filed on Sep. 10, 2021, entitled “TECHNIQUES FOR CONDITIONAL WAKE-UP SIGNAL MONITORING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for conditional wake-up signal (WUS) monitoring.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations (BSs) that can support communication for one or more user equipment (UEs). A UE may communicate with a BS via the downlink and uplink. The downlink (or forward link) refers to the communication link from the base stationBS to the UE, and the uplink (or reverse link) refers to the communication link from the UE to the base station. As will be described in more detail herein, a base station may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, from a network node, configuration information indicating a wake-up signal (WUS) configuration associated with a discontinuous reception (DRX) cycle, wherein the WUS configuration indicates one or more WUS occasions. The method may include identifying one or more conditions. The method may include refraining from monitoring at least one WUS occasion, from the one or more WUS occasions, based at least in part on the identification of the one or more conditions. The method may include monitoring one or more resources during an on duration associated with the DRX cycle.

Some aspects described herein relate to a UE for wireless communication. The UE may include a memory and one or more processors coupled to the memory. The one or more processors may be configured to receive, from a network node, configuration information indicating a WUS configuration associated with a DRX cycle, wherein the WUS configuration indicates one or more WUS occasions. The one or more processors may be configured to identify one or more conditions. The one or more processors may be configured to refrain from monitoring at least one WUS occasion, from the one or more WUS occasions, based at least in part on the identification of the one or more conditions. The one or more processors may be configured to monitor one or more resources during an on duration associated with the DRX cycle.

Some aspects described herein relate to a non-transitory computer-readable medium that stores a set of instructions for wireless communication by a UE. The set of instructions, when executed by one or more processors of the UE, may cause the UE to receive, from a network node, configuration information indicating a WUS configuration associated with a DRX cycle, wherein the WUS configuration indicates one or more WUS occasions. The set of instructions, when executed by one or more processors of the UE, may cause the UE to identify one or more conditions. The set of instructions, when executed by one or more processors of the UE, may cause the UE to refrain from monitoring at least one WUS occasion, from the one or more WUS occasions, based at least in part on the identification of the one or more conditions. The set of instructions, when executed by one or more processors of the UE, may cause the UE to monitor one or more resources during an on duration associated with the DRX cycle.

Some aspects described herein relate to an apparatus for wireless communication. The apparatus may include means for receiving, from a network node, configuration information indicating a WUS configuration associated with a DRX cycle, wherein the WUS configuration indicates one or more WUS occasions. The apparatus may include means for identifying one or more conditions. The apparatus may include means for refraining from monitoring at least one WUS occasion, from the one or more WUS occasions, based at least in part on the identification of the one or more conditions. The apparatus may include means for monitoring one or more resources during an on duration associated with the DRX cycle.

Aspects generally include a method, apparatus, system, computer program product, non-transitory computer-readable medium, user equipment, network node, network entity, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a discontinuous reception (DRX) configuration, in accordance with the present disclosure.

FIG. 4 is a diagram illustrating an example of wake-up signaling, in accordance with the present disclosure.

FIG. 5 is a diagram illustrating an example associated with conditional wake-up signal (WUS) monitoring, in accordance with the present disclosure.

FIG. 6 is a diagram illustrating an example process associated with conditional WUS monitoring, in accordance with the present disclosure.

FIGS. 7 and 8 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

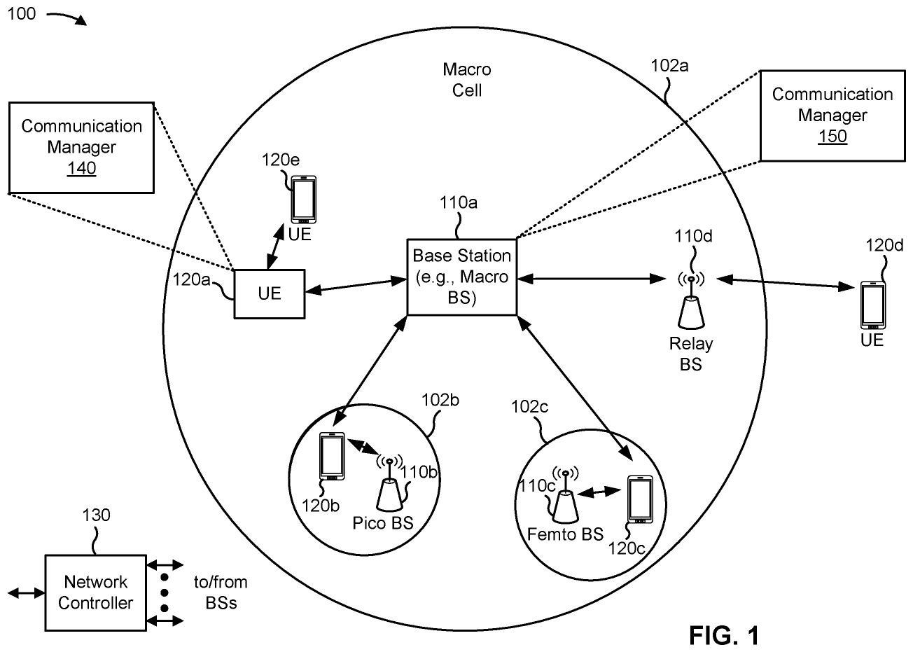

FIG. 1 is a diagram illustrating an example of a wireless network 100, in accordance with the present disclosure. The wireless network 100 may be or may include elements of a 5G (NR) network and/or an LTE network, among other examples. The wireless network 100 may include one or more base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A base station 110 for a macro cell may be referred to as a macro base station. A base station 110 for a pico cell may be referred to as a pico base station. A base station 110 for a femto cell may be referred to as a femto base station or a home base station. In the example shown in FIG. 1, a BS 110a may be a macro base station for a macro cell 102a, a BS 110b may be a pico base station for a pico cell 102b, and a BS 110c may be a femto base station for a femto cell 102c. A base station may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, the term “base station” (e.g., the base station 110) or “network node” or “network entity” may refer to an aggregated base station, a disaggregated base station, an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

In some examples, a cell may not necessarily be stationary, and the geographic area of the cell may move according to the location of a mobile BS. In some aspects, the base stations 110 may be interconnected to one another and/or to one or more other base stations 110 or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a base station 110 or a UE 120) and send a transmission of the data to a downstream station (e.g., a UE or a base station 110). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay base station may also be referred to as a relay station, a relay base station, a relay, or the like.

Wireless network 100 may be a heterogeneous network that includes base stations 110 of different types, such as macro base stations, pico base stations, femto base stations, relay base stations, or the like. These different types of base stations 110 may have different transmit power levels, different coverage areas, and different impacts on interference in wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to a set of base stations 110 and may provide coordination and control for these base stations 110. The network controller 130 may communicate with the base stations 110 via a backhaul. The base stations 110 may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs 120 may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHZ, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHZ). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

In some aspects, the UE 120 may include a communication manager 140. As described in more detail elsewhere herein, the communication manager 140 may receive, from a base station, configuration information indicating a wake-up signal (WUS) configuration associated with a discontinuous reception (DRX) cycle, wherein the WUS configuration indicates one or more WUS occasions; identify one or more conditions; refrain from monitoring at least one WUS occasion, from the one or more WUS occasions, based at least in part on the identification of the one or more conditions; and monitor one or more resources during an on duration associated with the DRX cycle. Additionally, or alternatively, the communication manager 140 may perform one or more other operations described herein.

In some aspects, the base station 110 may include a communication manager 150. The communication manager 150 may perform one or more perform one or more operations associated with the base station 110 as described in more detail elsewhere herein.

As indicated above, FIG. 1 is provided as an example. Other examples may differ from what is described with regard to FIG. 1.

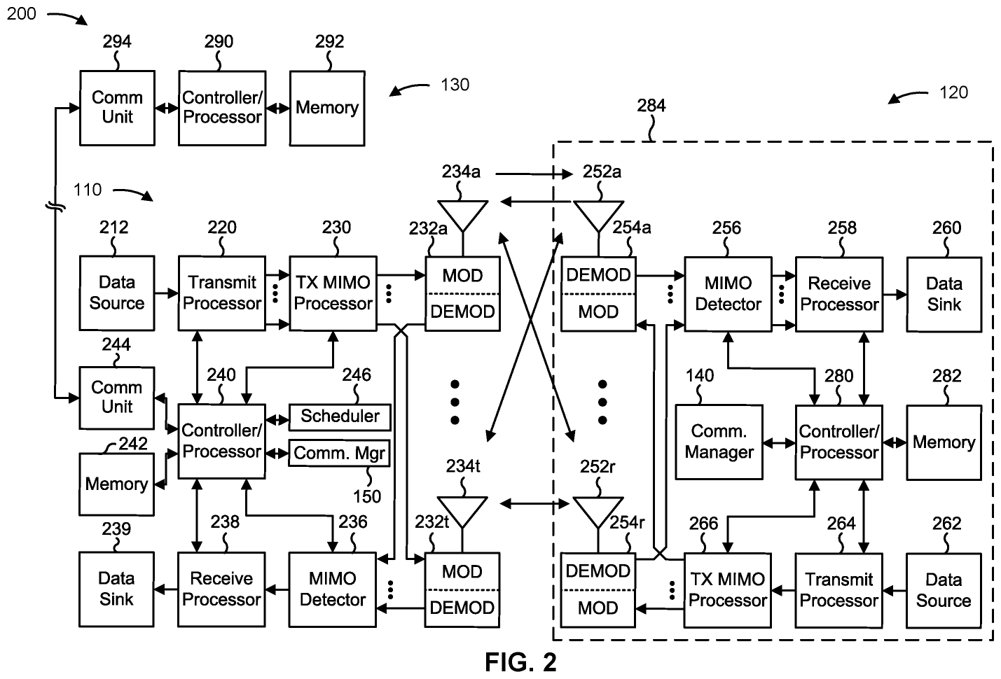

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to 7 modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, an/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein.

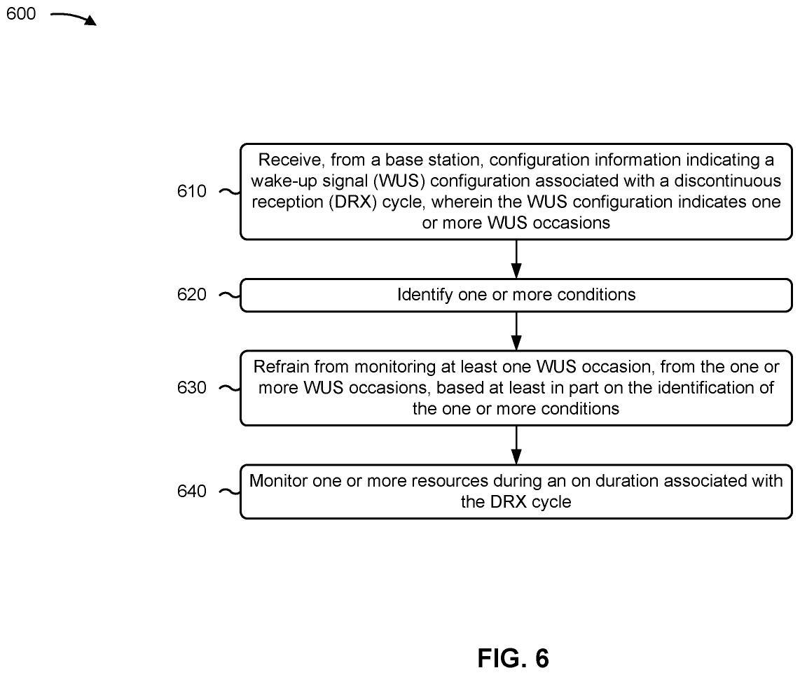

Controller/processor 240 of base station 110, controller/processor 280 of UE 120, and/or any other component(s) of FIG. 2 may perform one or more techniques associated with conditional WUS monitoring, as described in more detail elsewhere herein. For example, controller/processor 240 of base station 110, controller/processor 280 of UE 120, and/or any other component(s) of FIG. 2 may perform or direct operations of, for example, process 600 of FIG. 6, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, and/or other processes as described herein. In some aspects, executing instructions may include running the instructions, converting the instructions, compiling the instructions, and/or interpreting the instructions.

In some aspects, the UE 120 includes means for receiving, from a base station, configuration information indicating a WUS configuration associated with a DRX cycle, wherein the WUS configuration indicates one or more WUS occasions; means for identifying one or more conditions; means for refraining from monitoring at least one WUS occasion, from the one or more WUS occasions, based at least in part on the identification of the one or more conditions; and/or means for monitoring one or more resources during an on duration associated with the DRX cycle. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), TRP, or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

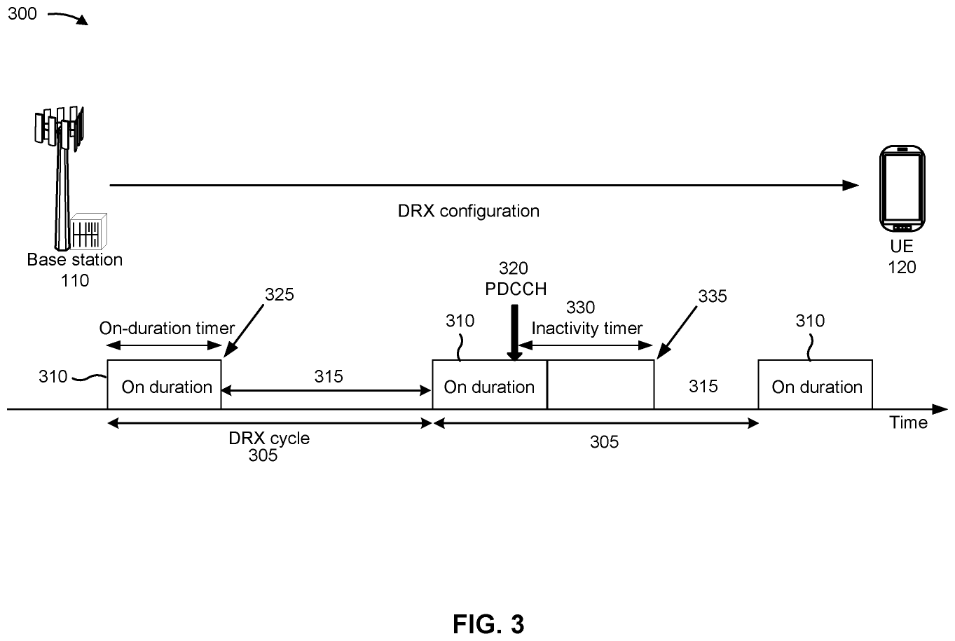

FIG. 3 is a diagram illustrating an example 300 of a DRX configuration, in accordance with the present disclosure.

As shown in FIG. 3, a base station 110 may transmit a DRX configuration to a UE 120 to configure a DRX cycle 305 for the UE 120. In some examples, the DRX cycle 305 may be referred to as a connected DRX (CDRX) cycle (e.g., a DRX cycle configured for the UE 120 that is operating in a connected mode, such as a radio resource control (RRC) connected mode). A DRX cycle 305 may include a DRX on duration 310 (e.g., during which a UE 120 is awake or in an active state) and an opportunity to enter a DRX sleep state 315. As used herein, the time during which the UE 120 is configured to be in an active state during the DRX on duration 310 may be referred to as an active time, and the time during which the UE 120 is configured to be in the DRX sleep state 315 may be referred to as an inactive time. As described below, the UE 120 may monitor a physical downlink control channel (PDCCH) during the active time, and may refrain from monitoring the PDCCH during the inactive time.

During the DRX on duration 310 (e.g., the active time), the UE 120 may monitor a downlink control channel (e.g., a PDCCH), as shown by reference number 320. For example, the UE 120 may monitor the PDCCH for downlink control information (DCI) pertaining to the UE 120. If the UE 120 does not detect and/or successfully decode any PDCCH communications intended for the UE 120 during the DRX on duration 310, then the UE 120 may enter the sleep state 315 (e.g., for the inactive time) at the end of the DRX on duration 310, as shown by reference number 325. In this way, the UE 120 may conserve battery power and reduce power consumption. As shown, the DRX cycle 305 may repeat with a configured periodicity according to the DRX configuration.

If the UE 120 detects and/or successfully decodes a PDCCH communication intended for the UE 120, then the UE 120 may remain in an active state (e.g., awake) for the duration of a DRX inactivity timer 330 (e.g., which may extend the active time). The UE 120 may start the DRX inactivity timer 330 at a time at which the PDCCH communication is received (e.g., in a transmission time interval (TTI) in which the PDCCH communication is received, such as a slot or a subframe). The UE 120 may remain in the active state until the DRX inactivity timer 330 expires, at which time the UE 120 may enter the sleep state 315 (e.g., for the inactive time), as shown by reference number 335. During the duration of the DRX inactivity timer 330, the UE 120 may continue to monitor for PDCCH communications, may obtain a downlink data communication (e.g., on a downlink data channel, such as a physical downlink shared channel (PDSCH)) scheduled by the PDCCH communication, and/or may prepare and/or transmit an uplink communication (e.g., on a physical uplink shared channel (PUSCH)) scheduled by the PDCCH communication. The UE 120 may restart the DRX inactivity timer 330 after each detection of a PDCCH communication for the UE 120 for an initial transmission (e.g., but not for a retransmission). By operating in this manner, the UE 120 may conserve battery power and reduce power consumption by entering the sleep state 315.

Various techniques have been introduced for transitioning a transceiver out of a power-saving mode and into an active mode. One technique includes transmitting a signal to the UE 120, which may indicate whether the UE 120 is to monitor an upcoming (or a next) on duration associated with the DRX cycle 305. The signal may be referred to as a WUS. The UE may temporarily transition out of the power-saving mode (e.g., by activating one or more modules and/or components, such as the baseband processor) to monitor the PDCCH for the WUS during a WUS occasion. The UE may use a relatively simple circuit to process the WUS, rather than powering on the associated modem and/or other components. In some examples, the UE 120 may monitor an on duration based on receiving a WUS from the base station 110. For example, if the UE 120 receives a WUS that indicates that the UE 120 is to monitor the subsequent on duration (e.g., or fails to decode a WUS in a WUS occasion in some cases), then the UE 120 may transition to the awake or active state and may monitor the PDCCH for DCI pertaining to the UE 120. If the UE 120 receives a WUS that indicates that the UE 120 is not to monitor the subsequent on duration, then the UE 120 may enter the sleep state 315 and may refrain from monitoring the PDCCH during the subsequent on duration. The WUS may enable the base station 110 to conserve resources for the UE 120 by enabling the base station 110 to indicate to the UE 120 when there will be traffic in an upcoming on duration and enabling the UE 120 to refrain from monitoring the on duration if there is no traffic to be communicated during the on duration. Accordingly, the base station 110 may use the WUS to increase the efficiency and power-saving of DRX operation by reducing the number of times that the UE 120 transitions to the active state.

The WUS may be transmitted via DCI (e.g., such as via a DCI using a DCI format 2-6, as defined by a wireless communication standard, such as the 3GPP). In some cases, the UE 120 may monitor time domain resources and/or frequency domain resources (which may be referred to as a “WUS occasion”) in which the base station 110 may transmit a DCI communication that includes the WUS. In some cases, the base station 110 may configure the UE 120 to periodically monitor WUS occasions for a WUS. The base station 110 may configure a WUS occasion to occur at an offset duration prior to a DRX on duration. The amount of time associated with the offset may be configured such that there is sufficient time between receiving the WUS and the DRX on duration for the UE 120 to transition from the sleep state 315 to the active state.

As indicated above, FIG. 3 is provided as an example. Other examples may differ from what is described with respect to FIG. 3.

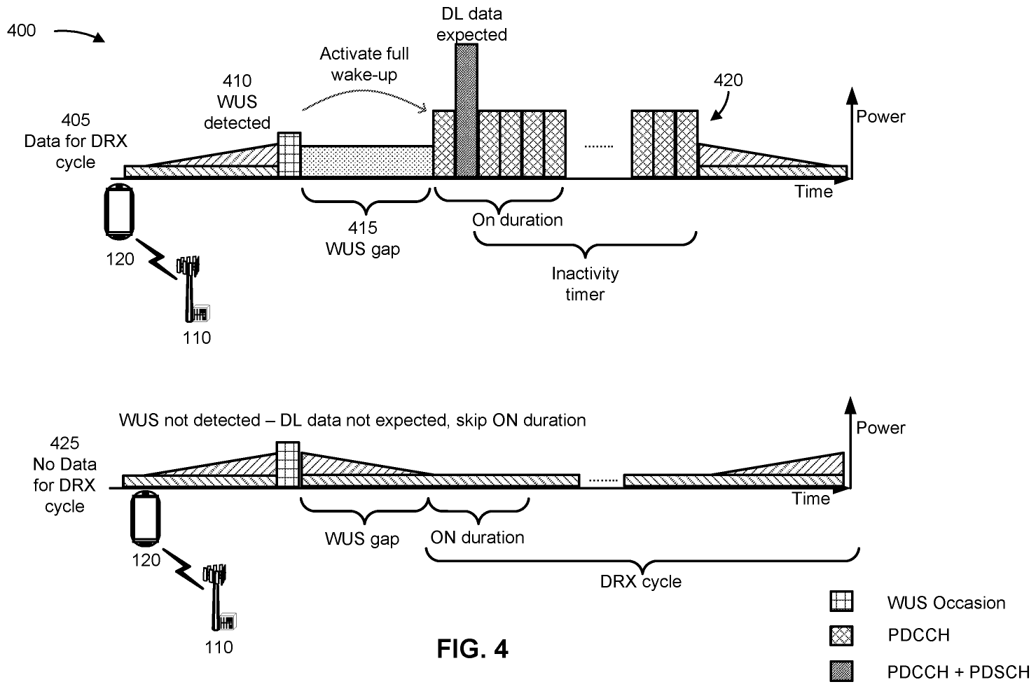

FIG. 4 is a diagram illustrating an example 400 of wake-up signaling, in accordance with the present disclosure. As shown in FIG. 4, example 400 includes a UE 120 in communication with a base station 110. In some cases, wake-up signaling in connection with a DRX cycle may be referred to as “DRX adaptation.”

As further shown in FIG. 4, and by reference number 405, in a first scenario a downlink grant may be provided for UE 120. For example, the base station 110 may determine that a downlink grant is to be provided to UE 120 during a first DRX cycle period to enable the UE 120 to receive queued data from the base station 110 during the DRX cycle period. As shown by reference number 410, the UE 120 may detect a WUS during a WUS occasion. In some examples, the WUS may be transmitted by the base station 110 to wake up the UE 120 so that the UE 120 can receive a data transmission. In some examples, the WUS may include a dedicated PDCCH communication transmitted by the base station 110 before a DRX (e.g., a CDRX) on duration to indicate whether the UE 120 should monitor the next DRX on duration.

In some examples, the WUS may be associated with a two-stage wake-up procedure. In a first stage, the UE 120 may wake up to a first level for PDCCH-WUS detection. If a WUS is detected and indicates “wake-up”, the UE 120 may wake up to a second level for monitoring for scheduling and reception of data. The first level and the second level may correspond to power modes. For example, in some aspects, the first level may be a low power mode and the second level may be a high power mode (e.g., a higher power mode than the low power mode). In some examples, during the first stage, low power mode, a minimal set of hardware may be instantiated or activated for PDCCH-only processing, the operating point in terms of voltage levels and clock frequencies of the hardware may be optimized, a more relaxed PDCCH processing timeline may be implemented, a receive bandwidth may be reduced, and/or a number of candidates and/or aggregation levels for PDCCH may be reduced, among other examples.

As shown, the UE 120 may take an amount of time to ramp up from a first level of power consumption for PDCCH-WUS detection to a second level of power consumption for monitoring for scheduling and reception of data. As shown by reference 415, a WUS gap may be configured as an amount of time between a WUS occasion and an on duration associated with the DRX cycle. In some aspects, a WUS occasion may be only a few symbols long. In some aspects, the UE 120 may ramp up according to a warm-up time. The WUS gap may be associated with a minimum warm-up threshold corresponding to the UE 120.

In some aspects, the inactivity timer associated with a DRX sleep mode may be triggered based at least in part on not decoding any grant from PDCCH reception. As shown by reference number 420, based at least in part on expiration of an inactivity timer, the UE 120 may transition to DRX sleep mode.

As shown by reference number 425, in a second scenario, a WUS may not be detected by the UE 120. For example, the base station 110 may determine that a downlink grant is not to be provided to the UE 120 during a second DRX cycle period (e.g., based at least in part on the base station 110 not having data queued for transmission to UE 120) and may not provide a WUS to wake up the UE 120, or the base station 110 may transmit a WUS indicating that the UE 120 is not to monitor the downlink channel during a subsequent on duration. As shown, the UE 120 may monitor a downlink channel to receive a WUS and may fail to receive a WUS, or the UE 120 may decode the WUS as “no wake-up.”

As described elsewhere herein, wake-up signaling may be used as a power-saving technique. However, in some cases, wake-up signaling may not conserve power consumed by the UE 120 and/or may actually increase power consumed by the UE 120. For example, as described above and as depicted in FIG. 4, the UE 120 may take an amount of time to ramp up (e.g., to power on hardware components) to monitor the PDCCH during a WUS occasion. Similarly, the UE 120 may take an amount of time to ramp down (e.g., to power down hardware components) after monitoring the PDCCH during the WUS occasion. The UE 120 may consume power during the ramp up and ramp down periods. Therefore, if the UE 120 is required to frequently monitor downlink channel(s) during both WUS occasions and on durations associated with the DRX cycle, then the wake-up signaling may not conserve power or energy consumed by the UE 120 (e.g., because the UE 120 is required to consume energy to monitor during the WUS occasion and during the on duration). In other words, in some cases, if the UE 120 monitors during a downlink channel during each WUS occasion and monitors the downlink channel during a number of on durations, the UE 120 may not conserve energy or power consumed by the UE 120 and/or may consume more energy or power than if the UE 120 were to use a conventional DRX cycle technique (e.g., without wake-up signaling).

Some techniques and apparatuses described herein enable conditional WUS monitoring. For example, the UE 120 may monitor a WUS occasion (or may refrain from monitoring a WUS occasion) based at least in part on one or more conditions. In some aspects, the UE 120 may disable a feature associated with wake-up signaling monitoring based at least in part on the one or more conditions. In some aspects, when the UE 120 refrains from monitoring a WUS occasion, or when the feature associated with wake-up signaling is disabled, the UE 120 may monitor a downlink channel during the on duration of the DRX cycle (e.g., without monitoring a downlink channel during the WUS occasion that precedes the on duration).

As a result, the UE 120 may be enabled to conditionally monitor WUS occasions when wake-up signaling conserves power or energy consumed by the UE 120. If the wake-up signaling does not conserve power and/or consumes additional power or energy, the UE 120 may be able to disable WUS occasion monitoring (e.g., may be enabled to refrain from monitoring one or more, or all, WUS occasions configured by the base station 110). As a result, the UE 120 may improve an efficiency associated with power saving in connection with wake-up signaling. Therefore, the UE 120 may conserve power and/or energy associated with a DRX cycle when the UE 120 is configured to monitor WUS occasions associated with the DRX cycle by conditionally monitoring the WUS occasions, as described herein.

In some aspects the one or more conditions may be based at least in part on a percentage or an amount of DRX on durations that are associated with traffic (e.g., a percentage or an amount of DRX on durations during which the UE 120 transmits or receives traffic). In some aspects, the one or more conditions may be based at least in part on a traffic type or a quality of service (QOS) flow associated with the UE 120. In some aspects, the one or more conditions may be based at least in part on WUS configuration (e.g., may be based at least in part on one or more offset values indicated by the WUS configuration). In some aspects, the one or more conditions may be based at least in on a channel state feedback (CSF) configuration and/or a channel state information (CSI) measurement and reporting configuration. In some aspects, the one or more conditions may be based at least in on synchronization signal configuration. In some aspects, the one or more conditions may be based at least in part on a number of activated cells or number of activated component carriers associated with the UE 120 (e.g., a number of activated secondary cells (SCells)). In some aspects, the one or more conditions may be based at least in part on uplink traffic statistics associated with the DRX cycle. In some aspects, the one or more conditions may be based at least in part on a percentage of, or a number of occurrences of, false wake-ups associated with the wake-up signaling.

In some aspects, the one or more conditions may indicate an energy consumption level by the UE 120 associated with the wake-up signaling. In some aspects, the UE 120 may refrain from monitoring a WUS occasion, or may disable WUS occasion monitoring, if one or more (or all) conditions are met or if one or more (or all) conditions indicate that energy will not be conserved (and/or will be consumed) in connection with the wake-up signaling. In some aspects, the UE 120 may adjust thresholds associated with a first condition based at least in part on a second condition being met (e.g., to make a condition for disabling WUS occasion monitoring easier to meet or harder to meet (e.g., loosening or restricting the condition)).

As indicated above, FIG. 4 is provided as an example. Other examples may differ from what is described with respect to FIG. 4.

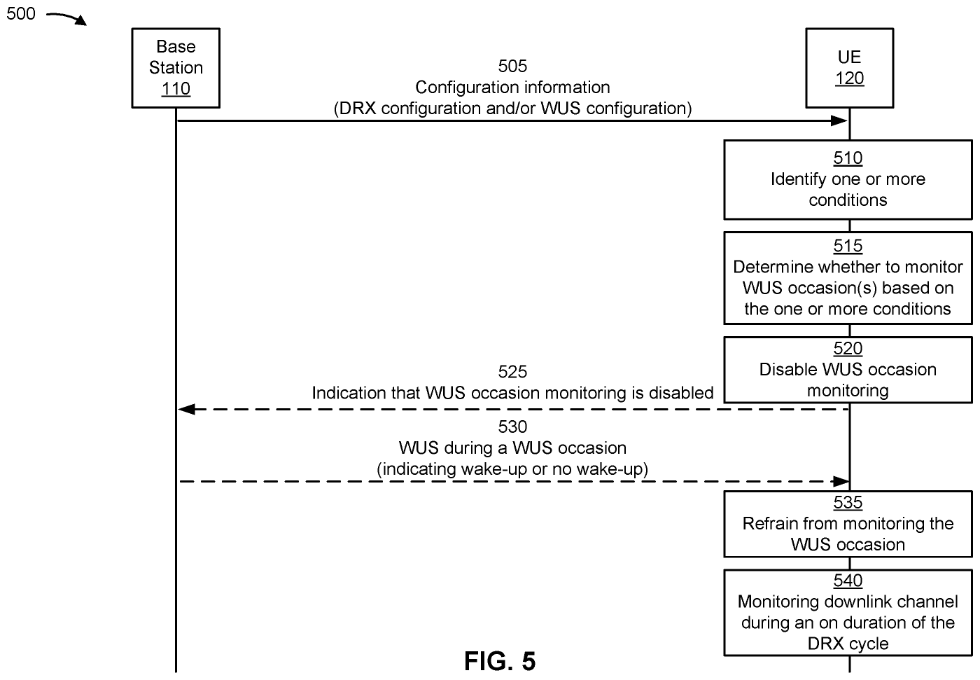

FIG. 5 is a diagram illustrating an example 500 associated with conditional WUS monitoring, in accordance with the present disclosure. As shown in FIG. 5, a base station 110 and a UE 120 may communicate with one another in a wireless network, such as the wireless network 100.

As shown by reference number 505, the base station 110 may transmit, and the UE 120 may receive, configuration information. In some aspects, the UE 120 may receive configuration information from another device (e.g., from another base station or another UE). In some aspects, the UE 120 may receive the configuration information via RRC signaling and/or medium access control (MAC) signaling (e.g., MAC control elements (MAC-CEs)). In some aspects, the configuration information may include an indication of one or more configuration parameters (e.g., already known to the UE 120) for selection by the UE 120 and/or explicit configuration information for the UE 120 to use to configure itself.

In some aspects, the configuration information may indicate that the UE 120 is to perform conditional WUS occasion monitoring, as described herein. For example, the UE 120 may be configured to determine whether to monitor one or more (or all) WUS occasions configured by the base station 110. In some aspects, the UE 120 may be configured to determine whether to monitor one or more (or all) WUS occasions based at least in part on one or more conditions. In some aspects, the configuration information may indicate the one or more conditions. In some other aspects, the UE 120 may determine the one or more conditions.

In some aspects, the configuration information may indicate a DRX configuration. The DRX configuration may configure a DRX cycle for the UE 120 (e.g., in a similar manner as described in connection with FIGS. 3 and 4). In some aspects, the configuration information may indicate a WUS configuration. The WUS configuration may configure one or more WUS occasions (e.g., time domain and/or frequency domain resources during which the UE 120 is to monitor a downlink channel for a WUS). Additionally, the WUS configuration may indicate one or more parameters associated with wake-up signaling. For example, the WUS configuration may indicate a first offset value indicating an amount of time before a start (or an initiation) of a DRX on duration that the WUS occasion can occur. The first offset value may be referred to as a PS offset (e.g., as defined, or otherwise fixed, by a wireless communication standard, such as the 3GPP).

In some aspects, the configuration information may indicate a control resource set (CORESET) configuration and/or a search space configuration associated with the WUS configuration. For example, the UE 120 may be configured to monitor during a monitoring window that includes one or more of the PDCCH candidate locations configured for the UE 120 by the CORESET configuration and/or search space configuration (e.g., a subset of the PDCCH candidate locations configured for the UE 120 by the CORESET configuration and/or search space configuration) that the UE 120 is to monitor for a WUS (e.g., the CORESET configuration may indicate frequency domain resources to be monitored and the search space configuration may indicate time domain resources to be monitored). The monitoring window may be configured for the UE 120 with a duration that is defined as a time interval, a quantity of PDCCH candidate locations, a quantity of slots, and/or a quantity of control channel elements, among other examples. The UE 120 may monitor a search space set for the WUS in the monitoring window configured for the UE 120 (e.g., only monitoring occasions that fall within the monitoring window are monitored by the UE 120 for the WUS). The configuration information may indicate a search space set periodicity associated with the search space sets. In some aspects, the configuration information may indicate a number (or which) symbols within a slot (e.g., via a monitoringSymbolsWithinSlot parameter) are to be monitored by the UE 120 during the monitoring window (or during a WUS occasion). The monitoring window may start at the first offset value (e.g., the PS offset value indicated by the configuration information) before a start of a DRX ON duration.

In some aspects, the configuration information may indicate a CSF configuration. The CSF configuration may indicate a measurement and/or reporting configuration, such as a CSI measurement and/or reporting configuration. The measurement and/or reporting configuration may indicate a periodic CSI measurement and reporting (e.g., that is independent of a WUS indication). For example, the configuration information may indicate that the UE 120 is to measure and/or report CSI during an on duration of the DRX cycle regardless of whether a WUS indicates that the UE 120 is to monitor the downlink channel during the on duration. For example, the configuration information may indicate that the UE 120 is to transmit a CSI report periodically. If a reference signal to be measured by the UE 120 is scheduled to be transmitting and/or if a reporting occasion occurs during an on duration of the DRX cycle, then the UE 120 may measure the reference signal and/or transmit the measurement report (e.g., even if no WUS is transmitted and/or if a WUS indicates that the on duration can be skipped by the UE 120). The configuration information may indicate the periodic CSI measurement and reporting via a ps-TransmitPeriodicL1-RSRP parameter and/or a ps-TransmitOtherPeriodicCSI parameter, among other examples (e.g., as defined, or otherwise fixed, by a wireless communication standard, such as the 3GPP). The parameters may enable the downlink channel to remain active (e.g., for the UE 120 to monitor the downlink channel) even when a WUS indicates “no wake-up” for one or more DRX on durations.

In some aspects, the UE 120 may configure the UE 120 for communicating with the base station 110. In some aspects, the UE 120 may configure the UE 120 based at least in part on the configuration information. In some aspects, the UE 120 may be configured to perform one or more operations described herein.

In some aspects, the UE 120 may transmit, and the base station 110 may receive, an indication of a capability of the UE 120 to perform conditional WUS occasion monitoring, as described herein. For example, the UE 120 may indicate a capability of the UE 120 to communicate using conditional WUS occasion monitoring. In some aspects, the UE 120 may transmit the indication via RRC signaling, one or more MAC-CEs, and/or a physical uplink control channel (PUCCH) message, among other examples. The UE 120 may transmit the indication in a UE capability message or a UE information message (e.g., a UE assistance information message).

In some aspects, the UE 120 may transmit, and the base station 110 may receive, an indication of a capability of the UE 120 associated with wake-up signaling. For example, the UE 120 may transmit an indication of a second time offset value that indicates a minimum amount of time between a WUS occasion and a start of an on duration (e.g., a minimum amount of time needed for the UE 120 to process the WUS and to transition to monitoring the downlink channel during the on duration). The second time offset value may be indicated via a MinTimeGap parameter (or a MinTimeGap-r16 parameter as defined, or otherwise fixed, by a wireless communication standard, such as the 3GPP) for WUS monitoring in a UE capability message.

As shown by reference number 510, the UE 120 may identify one or more conditions. In some aspects, the one or more conditions may be based at least in part on the WUS configuration; a search space set configuration; a minimum time gap (e.g., the MinTimeGap) indicated by capability information associated with the UE 120, between on durations associated with the DRX cycle and WUS monitoring occasions; a time offset (e.g., the PS offset) indicated by the configuration information, between on durations associated with the DRX cycle and a first time that WUS monitoring occasions can occur; a duration of the one or more WUS monitoring occasions; and/or a PDCCH monitoring configuration (e.g., a CORESET configuration), among other examples. In some aspects, the one or more conditions may be based at least in part on the CSF configuration and/or a CSI configuration (e.g., a CSI reporting and measurement configuration). In some aspects, the one or more conditions may be based at least in part on a synchronization signal configuration (e.g., a timing of one or more synchronization signal blocks (SSBs) to be transmitted by the base station 110). In some aspects, the one or more conditions may be based at least in part on uplink statistics associated with the DRX cycle (e.g., frequency or percentage of scheduling requests or a percentage of active time, associated with the DRX cycle, that is associated with uplink traffic). In some aspects, the one or more conditions may be based at least in part on a number of activated component carriers or cells (e.g., a number of active SCells or secondary component carriers). In some aspects, the one or more conditions may be based at least in part on a percentage of false wake-ups associated with the DRX cycle. As described in more detail elsewhere herein, “false wake-up” may refer to a scenario in which the UE 120 receives a WUS indicating that the UE 120 is to wake-up or the UE 120 fails to decode a WUS during a WUS occasion (e.g., and a default behavior is to wake-up when no WUS is decoded during a WUS occasion), but no traffic is received during a corresponding on duration of the DRX cycle (e.g., during a next on duration after the UE 120 wakes up). In some aspects, the one or more conditions may be based at least in part on an energy consumption metric associated with monitoring WUS occasions. The energy consumption metric may be based at least in part on the one or more conditions and may indicate a level or an amount of energy to be consumed by the UE 120 based at least in part on monitoring the WUS occasions configured by the base station 110. The one or more conditions and/or the identification of the one or more conditions are described in more detail elsewhere herein.

In some aspects, the UE 120 may identify a condition based at least in part on the PS_offset value configured by the base station 110 and/or the WUS configuration. For example, a timing of WUS occasions may be based at least in part on the PS_offset value configured by the base station 110, a minimum time gap value indicated by the UE 120, and/or a search space set configuration (e.g., a monitoring periodicity, a search space set periodicity, and/or an offset configuration) for a search space set associated with WUS occasion monitoring. For example, the minimum time gap value indicated by the UE 120 may only guarantee a minimum time gap between a WUS occasion and a start of an on duration. An actual timing and/or duration of a WUS occasion may be based at least in part on the PS_offset value configured by the base station 110 and/or the search space set configuration. For example, wake-up signaling may be group common signaling (e.g., may be associated with multiple UEs). Therefore, to facilitate timing alignment of a WUS occasion across multiple UEs (e.g., that may have different minimum time gap values, different DRX configurations, and/or different search space set configurations), the base station 110 may configure a larger PS_offset value to provide more flexibility to the base station 110 in configuring a timing of the WUS occasions. However, as an amount of time between a start of an on duration and a WUS occasion increases, a power saving associated with the wake-up signaling may decrease. Therefore, as the configured PS_offset value increases (e.g., increasing a potential amount of time between a WUS occasion and a start of an on duration), a power saving gain due to wake-up signaling may decrease.

The identification of a condition may be based at least in part on the time offset value configured by the base station 110 for the wake-up signaling (e.g., the PS_offset value). For example, the UE 120 may identify that a condition is met based at least in part on identifying that the time offset value (e.g., the PS_offset value) satisfies a first threshold (e.g., a PS_offset threshold). The identification that the condition is met may trigger the UE 120 to disable WUS occasion monitoring (e.g., as explained in more detail elsewhere herein). For example, the first threshold may be associated with a value of 8 milliseconds, among other examples (e.g., when the DRX configuration indicates a DRX cycle duration of 160 milliseconds, an on duration of 10 milliseconds, and an inactivity timer duration of 100 milliseconds). For example, a value associated with the first threshold may be based at least in part on the DRX configuration. In some aspects, the value associated with the first threshold may be based at least in part on an on duration value indicated by the DRX configuration. For example, the value associated with the first threshold may be the on duration value (e.g., if the one duration is 10 milliseconds, then the value associated with the first threshold may be 10 milliseconds). As another example, the value associated with the first threshold may be based at least in part on the on duration value modified by a factor I. (e.g., the PS_offset threshold=L·on duration value). L may have a value less than one (1), equal to one (1), or greater than one (1). For example, if the one duration is 10 milliseconds and a value of L is 0.8, then the first threshold (e.g., the PS_offset threshold) may be 8 milliseconds.

In some aspects, the identification of a condition may be based at least in part on a duration of the WUS occasions configured by the base station 110. Additionally, or alternatively, the identification of a condition may be based at least in part on a number of WUS occasions (e.g., over a given time period) configured by the base station 110. In some aspects, the given time period may be a period of time between on durations associated with the DRX cycle. For example, the UE 120 may identify that a condition is met based at least in part on multiple WUS occasions being configured within a time period, where the multiple WUS occasions span more than N slots. In other words, the UE 120 may identify that a number of slots associated with the one or more WUS monitoring occasions configured by the base station 110 satisfies a second threshold (e.g., N). The identification that the condition is met may trigger the UE 120 to disable WUS occasion monitoring (e.g., as explained in more detail elsewhere herein). In some aspects, N may be associated with a value of one (e.g., one slot).

In some aspects, the one or more conditions may be associated with one or more thresholds, such as the first threshold, the second threshold, and/or other thresholds. A value associated with a threshold, of the one or more thresholds, may be based at least in part on a scheduling rate of traffic activity associated with the UE 120. For example, a value associated with a threshold may be different for different scheduling rates (e.g., different traffic activity levels). In some aspects, a value associated with a threshold, of the one or more thresholds, may be based at least in part on a carrier aggregation configuration (e.g., based at least in part on a number of carriers, component carriers, or cells configured). For example, a value associated with a threshold may be different when different numbers of cells or different numbers of component carriers are configured for the UE 120.

In some aspects, the identification of a condition may be based at least in part on a CSF configuration or a CSI configuration received from the base station 110. For example, the identification of a condition may be based at least in part on a periodic CSI measurement and reporting configuration. For example, as described elsewhere herein, the configuration information may indicate that CSI measurement and reporting (or other measurement or reporting) is to occur periodically. If a measurement or reporting occasion is scheduled to occur during an on duration associated with the DRX cycle (e.g., as indicated by the CSF configuration or the CSI configuration), then the UE 120 may be configured to measure and/or transmit measurement reports during the on duration regardless of an indication of a WUS associated with the on duration (e.g., even if the WUS indicates “no wake-up” or that the on duration can be skipped, the UE 120 may still wake up and measure and/or report measurements during the on duration). Therefore, the UE 120 may identify that a condition is met based at least in part on identifying that at least one periodic CSI measurement and reporting parameters indicates that a CSI measurement and reporting is to occur during on durations associated with the DRX cycle. For example, if the ps-TransmitPeriodicL1-RSRP parameter and/or the ps-TransmitOtherPeriodicCSI parameter is configured as “true,” and if a timing for CSI measurement and/or reporting indicates that the measurement and/or reporting is to occur during at least one on duration associated with the DRX cycle, then the UE 120 may identify that a condition is met. The identification that the condition is met may trigger the UE 120 to disable WUS occasion monitoring (e.g., as explained in more detail elsewhere herein). In other words, because the UE 120 may be required to perform communication activities during the on duration (e.g., due to the CSI or CSF configuration), the UE 120 may skip WUS occasion monitoring to save power because the UE 120 has to wake up during the on durations for measurement and/or reporting regardless of the indication from the WUS.

In some aspects, the UE 120 may identify DRX cycles and/or on durations that are associated with measurement and/or reporting activities (e.g., as indicated by the CSF configuration or the CSI configuration). For example, the measurement and/or reporting activities may be scheduled to occur periodically. Similarly, the on durations associated with the DRX cycle may occur periodically. However, these periods may be different. Therefore, measurement and/or reporting activities may be scheduled to occur during some, but not all, on durations configured for the UE 120. For example, on durations may occur periodically every 160 milliseconds. Measurement and/or reporting activities may be scheduled to occur every 320 milliseconds. A timing of the measurement and/or reporting activities may align with the on durations (e.g., may occur during the on durations). However, because the periods are different, the measurement and/or reporting activities may only occur during half the (e.g., every other) on durations configured for the UE 120. Therefore, the UE 120 may identify the DRX cycles and/or the on durations that are associated with measurement and/or reporting activities. The UE 120 may refrain from monitoring WUS occasions associated with the identified DRX cycles and/or on durations that are associated with measurement and/or reporting activities, as explained in more detail elsewhere herein. For example, rather than transitioning to a microsleep mode after monitoring a WUS occasion and before performing measurement and/or reporting activities, the UE 120 may refrain from monitoring the WUS occasion (e.g., and remain in a deeper sleep mode that is associated with more power savings that the microsleep mode) and may wake up (e.g., power on hardware components) during the on duration to perform the measurement and/or reporting activities, thereby improving an efficiency of the power usage of the UE 120. The UE 120 may continue to monitor WUS occasions that are associated with DRX cycles and/or on durations that are not associated with measurement and/or reporting activities.

In some aspects, the UE 120 may identify that no CSI configuration or CSF configuration are configured (e.g., the ps-TransmitPeriodicL1-RSRP parameter and/or the ps-TransmitOtherPeriodic (SI parameter may be configured as “false”) or that a configured CSI configuration indicates that measurement and/or reporting is to occur outside of on durations associated with the DRX cycle. In such examples, the UE 120 may perform one or more actions to make it more difficult to disable WUS occasion monitoring. For example, the UE 120 may adjust values associated one or more thresholds of other conditions (e.g., other conditions described herein) to make the other condition(s) more difficult to meet.

In some aspects, the identification of a condition may be based at least in part on a synchronization signal (SS) configuration (e.g., indicated by the configuration information). For example, the SS configuration may indicate a timing or periodicity associated with one or more SSBs. The identification of a condition may be based at least in part on the timing or periodicity associated with the SSBs. For example, if an amount of time between WUS monitoring occasions and SSBs satisfies a third threshold, then the UE 120 may identify that the condition is not met. If the amount of time between WUS monitoring occasions and SSBs does not satisfy the third threshold, then the UE 120 may identify that the condition is met. The identification that the condition is met may trigger the UE 120 to disable WUS occasion monitoring (e.g., as explained in more detail elsewhere herein). In other words, if a timing of the SSBs occurs close to the WUS monitoring occasions, then the UE 120 may monitor the WUS occasions and receive the SSB together (e.g., without powering down hardware components) to improve an efficiency associated with a power usage by the UE 120. However, if a timing of the SSBs occurs further from the WUS monitoring occasions (or occurs closer to an on duration than the WUS monitoring occasions), then the UE 120 may skip (or refrain from monitoring) the WUS occasions and may monitor the downlink channel during the on durations and receive the SSB together (e.g., without powering down hardware components) to improve the efficiency associated with an energy usage by the UE 120.

In some aspects, the identification of a condition may be based at least in part on statistics associated with the configured DRX cycle. The statistics may be determined by the UE 120 over a sliding or moving time window (e.g., the statistics may be based at least in part on traffic communicated by the UE 120 over the last M DRX cycles, the last M on durations, and/or over the last S milliseconds). For example, the identification of a condition may be based at least in part on a number of on durations, associated with the DRX cycle, that are associated with receiving or transmitting traffic. For example, the UE 120 may identify a percentage of served on durations associated with the DRX cycle (e.g., during the sliding or moving time window). “Served on duration” may refer to an on duration during which the UE 120 received downlink traffic or transmitted uplink traffic. The UE 120 may identify that the percentage of served on durations (e.g., during the sliding or moving time window) satisfies a fourth threshold. The UE 120 may identify that a condition is met based at least in part on the percentage of served on durations associated with the DRX cycle satisfying the fourth threshold. The identification that the condition is met may trigger the UE 120 to disable WUS occasion monitoring (e.g., as explained in more detail elsewhere herein). For example, when a high number of on durations are associated with traffic, it may be more energy efficient for the UE 120 to skip WUS occasion monitoring and simply monitor each on duration associated with the DRX cycle. Therefore, rather than monitoring each WUS occasion and a high number of on durations associated with the DRX cycle, the UE 120 may skip the monitoring of the WUS occasions and monitor the downlink channel during each on duration to improve the efficiency of energy usage by the UE 120.

In some aspects, the identification of a condition may be based at least in part on a traffic type or a QoS flow associated with the UE 120. For example, for some traffic types, QoS flows, and/or applications, a scheduling rate of traffic may be known (e.g., known by the UE 120) to be high and/or predictable. Therefore, if the UE 120 identifies a traffic type or a QoS flow, then the UE 120 may identify that a condition is met. The identification that the condition is met may trigger the UE 120 to disable WUS occasion monitoring (e.g., as explained in more detail elsewhere herein). For example, voice traffic or video traffic, such as voice over NR (VoNR) traffic, may be associated with high scheduling rates (e.g., may be associated with the UE 120 frequently receiving downlink packets or transmitting uplink packets). Therefore, if the UE 120 identifies that traffic associated with the UE 120 is voice traffic, video traffic, or VoNR traffic, the UE 120 may refrain from monitoring WUS occasions and may monitor the downlink channel during the on durations to improve the efficiency of energy usage by the UE 120 (e.g., because the UE 120 may know that it is likely that the UE 120 will receive or transmit traffic during the on durations due to the traffic type or QoS flow).

In some aspects, the identification of a condition may be based at least in part on uplink statistics (e.g., statistics associated with uplink traffic) associated with the DRX cycle. For example, the identification of a condition may be based at least in part on how frequently the UE 120 is transmitting uplink communications during on durations associated with the DRX cycle. For example, the identification of a conditions may be based at least in part on a frequency of scheduling requests associated with the DRX cycle. In some aspects, the identification of a conditions may be based at least in part on a percentage of active time, associated with the DRX cycle, that is associated with uplink traffic. For example, the UE 120 may identify that a condition is met based at least in part on identifying that a number of scheduling requests transmitted by the UE 120 over a time period satisfies a fifth threshold. In some aspects, the UE 120 may identify that a condition is met based at least in part on identifying that an average number of scheduling requests transmitted by the UE 120 every 7 milliseconds satisfies the fifth threshold. For example, the UE 120 may identify that (over a sliding or moving time window) the average number of scheduling requests transmitted by the UE 120 every T milliseconds (such as every 160 milliseconds) satisfies the fifth threshold. The value of T and/or the value of the first threshold may be based at least in part on the DRX configuration (e.g., a duration of the DRX cycle and/or a duration of the on durations, among other examples). As another example, the UE 120 may identify that a condition is met based at least in part on identifying that a percentage of active time, associated with the DRX cycle, that is associated with uplink traffic (e.g., over a sliding or moving time window) satisfies a sixth threshold. The identification that the condition is met may trigger the UE 120 to disable WUS occasion monitoring (e.g., as explained in more detail elsewhere herein).

In some aspects, the identification of a condition may be based at least in part on a carrier aggregation configuration associated with the UE 120. Carrier aggregation is a technology that enables two or more component carriers (CCs) to be combined (e.g., into a single channel) for a single UE 120 to enhance data capacity. A CC may sometimes be referred to as a carrier. In carrier aggregation, a UE 120 may be configured with a primary carrier or primary cell (PCell) and one or more secondary carriers or SCells. In some aspects, the primary carrier may carry control information (e.g., downlink control information and/or scheduling information) for scheduling data communications on one or more secondary carriers, which may be referred to as cross-carrier scheduling. A secondary carrier or an SCell may be used to increase data capacity (e.g., and may not carry control information). In some aspects, the identification of a condition may be based at least in part on a number of activated secondary carriers or activated SCells. For example, the UE 120 may identify a condition is met based at least in part on identifying that the number of activated secondary carriers or activated SCells is less than a seventh threshold. For example, wake-up signaling may be transmitted via a primary carrier or a PCell and may be applied to all activated secondary carriers or SCells. Therefore, an energy efficiency associated with wake-up signaling may increase as the number of activated secondary carriers or SCells increases. As a result, if a number of activated CCs (or a number of activated secondary carriers or SCells) is above a threshold, then the UE 120 may override a determination to disable WUS occasion monitoring (e.g., that was determined based at least in part on other condition(s) being met, as described herein). In some aspects, if the UE 120 identifies that a number of activated CCs (or a number of activated secondary carriers or SCells) is above a threshold, then the UE 120 may perform one or more actions to make it more difficult to disable WUS occasion monitoring. For example, the UE 120 may adjust values associated one or more thresholds of other conditions (e.g., other conditions described herein) to make the other condition(s) more difficult to meet.

In some aspects, the identification of a condition may be based at least in part on a percentage or number of occurrences of false wake-ups associated with the DRX cycle. The percentage or number of occurrences of false wake-ups associated with the DRX cycle may be determined by the UE 120 over a sliding or moving time window (e.g., over the last Z milliseconds). For example, the UE 120 may identify a percentage or a number of occurrences of false wake-ups associated with the DRX cycle over a sliding time window (e.g., the percentage of false-wake ups may be determined based at least in part on the number of occurrences of false-wake ups). The UE 120 may identify that a condition is met based at least in part on identifying that the percentage or number of occurrences of false wake-ups satisfying an eighth threshold. The identification that the condition is met may trigger the UE 120 to disable WUS occasion monitoring (e.g., as explained in more detail elsewhere herein).

As shown by reference number 515, the UE 120 may determine whether to monitor WUS occasions based at least in part on the one or more conditions. For example, the UE 120 may determine whether to disable WUS occasion monitoring based at least in part on identifying that one or more conditions are met, as described in more detail elsewhere herein. For example, in some aspects, the UE 120 may disable WUS occasion monitoring based at least in part on identifying that any single condition is met. In some aspects, the UE 120 may disable WUS occasion monitoring based at least in part on a threshold number of conditions being met. In some aspects, the conditions may be associated with a priority (e.g., some conditions may have a greater weight for the determination to disable WUS occasion monitoring than other conditions). For example, in some cases, the UE 120 may identify if a first condition is met. If the first condition is met, then the UE 120 may determine to disable WUS occasion monitoring. If the first condition is not met, then the UE 120 may identify if a second condition is met. If the second condition is met, then the UE 120 may determine to disable WUS occasion monitoring. If the second condition is not met, then the UE 120 continue to a third condition in a similar manner. In some aspects, the UE 120 may identify a subset of WUS occasions, from a set of configured WUS occasions, that are to be skipped (e.g., that are not to be monitored by the UE 120) based at least in part on the identification of the one or more conditions, as described herein.

In some aspects, the UE 120 may determine whether to disable WUS occasion monitoring using a unified approach that is based at least in part on multiple conditions. For example, in some aspects, the UE 120 may determine whether to disable WUS occasion monitoring based at least in part on an energy consumption metric. The energy consumption metric may be associated with an energy consumption by the UE 120 that would occur by monitoring the one or more WUS monitoring occasions in accordance with the configuration information. The energy consumption metric may be based at least in part on the one or more conditions. For example, the UE 120 may determine the energy consumption metric by taking one or more (or all) of the conditions described herein into account to determine an amount of energy that would be consumed by the UE 120 with WUS occasion monitoring enabled vs. with WUS occasion monitoring disabled. The energy consumption metric may indicate an amount of time that the UE 120 is required to have hardware components powered on (e.g., based at least in part on the one or more conditions). In some aspects, the energy consumption metric may indicate an amount of power or energy that would be consumed by the UE 120 with WUS occasion monitoring enabled vs. with WUS occasion monitoring disabled. The UE 120 may determine to disable WUS occasion monitoring based at least in part on the energy consumption metric indicating that the UE 120 would consume less energy with WUS occasion monitoring disabled compared with WUS occasion monitoring enabled.

As shown by reference number 520, the UE 120 may disable WUS occasion monitoring. For example, the UE 120 may disable WUS occasion monitoring based at least in part on determining to disable WUS occasion monitoring (e.g., as described in more detail elsewhere herein). In some aspects, the UE 120 may disable WUS occasion monitoring based at least in part the identification of one or more conditions (e.g., as described in more detail elsewhere herein). Disabling WUS occasion monitoring may cause the UE 120 to refrain from monitoring (e.g., to refrain from powering on one or more hardware components to monitor) the downlink channel during WUS occasions configured by the base station 110. In some aspects, the UE 120 may disable WUS occasion monitoring for an amount of time based at least in part on determining to disable WUS occasion monitoring. The UE 120 may reevaluate whether to continue to disable WUS occasion monitoring after the amount of time (e.g., in a similar manner as described elsewhere herein). In some aspects, the UE 120 may disable WUS occasion monitoring until the UE 120 determines that WUS occasion monitoring should be enabled. The UE 120 may determine that WUS occasion monitoring should be enabled based at least in part on the one or more conditions described elsewhere herein. For example, the UE 120 may determine that WUS occasion monitoring should be enabled based at least in part on changing conditions, changing configurations, and/or changing traffic types associated with the UE 120.

In some aspects, the UE 120 may autonomously (e.g., without communicating with the base station) disable the WUS occasion monitoring. Alternatively, as shown by reference number 525, the UE 120 may transmit, and the base station 110 may receive, an indication to disable or de-configure at least one WUS monitoring occasion (e.g., a WUS monitoring occasion that the UE 120 has determined to refrain from monitoring, as described in more detail elsewhere herein). For example, the UE 120 may transmit the indication to disable or de-configure at least one WUS monitoring occasion (or all WUS monitoring occasions) based at least in part on disabling WUS occasion monitoring. This may enable the base station 110 to disable WUS occasion monitoring for the UE 120, thereby conserving resources that would have otherwise been used by the base station 110 to transmit a WUS during a WUS occasion that is not monitored by the UE 120. The UE 120 may transmit the indication to disable or de-configure at least one WUS monitoring occasion via higher layer signaling. For example, the UE 120 may transmit the indication via a dynamic UE capability message. For example, if the UE 120 determines to disable WUS occasion monitoring, the UE 120 may transmit a UE capability message indicating that the UE 120 does not support, or does not have the capability for, wake-up signaling. As another example, the UE 120 may transmit the indication via a UE assistance information message. The base station 110 may transmit, and the UE 120 may receive, a message indicating that one or more (or all) WUS occasions are no longer configured for the UE 120 based at least in part on the UE 120 transmitting the indication.

As shown by reference number 530, the base station 110 may transmit, and the UE 120 may receive, a WUS during a WUS occasion. The WUS may include a “wake up” indication (e.g., indicating that there is traffic to be communicated during an upcoming on duration associated with the DRX cycle) or a “no wake-up” indication (e.g., indicating that there is no traffic to be communicated during an upcoming on duration associated with the DRX cycle and that the upcoming DRX cycle can be skipped or not monitored by the UE 120). For example, as described elsewhere herein, the UE 120 may autonomously (e.g., without notifying the base station 110) disable WUS occasion monitoring. Therefore, the base station 110 may still transmit a WUS during a WUS occasion, even if the UE 120 has disabled WUS occasion monitoring.

As shown by reference number 535, the UE 120 may refrain from monitoring at least one WUS monitoring occasion, from the one or more (or all) WUS monitoring occasions configured by the base station 110, based at least in part on the identification of the one or more conditions. For example, the UE 120 may refrain from monitoring at least one WUS monitoring occasion based at least in part on disabling WUS occasion monitoring. For example, the UE 120 may refrain from monitoring the WUS occasion during which the base station 110 transmitted the WUS. Refraining from monitoring the WUS occasion may include the UE 120 refraining from monitoring a downlink channel (e.g., the PDCCH) during the WUS occasion. For example, the UE 120 may refrain from powering on (or increasing an amount of power provided to) one or more hardware components, that are associated with monitoring the downlink channel, during the WUS occasion. Refraining from monitoring the WUS occasion may enable the UE 120 to conserve power or energy that would have otherwise been used to monitor the downlink channel during the WUS occasion. Moreover, refraining from monitoring the WUS occasion may enable the UE 120 to maintain operation in a power saving mode (e.g., a sleep mode or a sleep state) for an increased amount of time, thereby improving the efficiency associated with energy consumption by the UE 120.

As shown by reference number 540, the UE 120 may monitor one or more resources (e.g., time domain resources and/or frequency domain resources) during an on duration associated with the DRX cycle. For example, the UE 120 may monitor a downlink channel during the on duration associated with the DRX cycle. The on duration may be a next on duration in the time domain after the WUS occasion that was skipped by the UE 120 (e.g., that was not monitored by the UE 120, as described in connection with reference number 535). In other words, when a WUS occasion is not monitored by the UE 120, the UE 120 may operate as if no wake-up signaling were configured (e.g., the UE 120 may wake up to monitor the on duration associated with the DRX cycle, in a similar manner as described in connection with FIG. 3). The UE 120 may receive or transmit one or more communications during the on duration. In some aspects, the UE 120 may measure one or more signals transmitted by the base station 110 during the on duration.

In some aspects, one or more (or all) operations or actions described herein as being performed by the UE 120 may be performed by the base station 110. For example, the base station 110 may evaluate the conditions and determine whether WUS occasion monitoring should be disabled for the UE 120, in a similar manner as described elsewhere herein. In such examples, the base station 110 may transmit, and the UE 120 may receive, an indication to refrain from monitoring the at least one WUS monitoring occasion. The UE 120 may identify that one or more conditions are met, may determine to disable WUS occasion monitoring, and/or may refrain from monitoring a WUS occasion (e.g., as described elsewhere herein) based at least in part on the reception of the indication from the base station 110. In some aspects, the indication may de-configure wake-up signaling (e.g., may remove the WUS configuration). In some aspects, the indication may disable WUS occasion monitoring at the UE 120 (e.g., for a period of time), but may keep the WUS configuration as configured at the UE 120 (e.g., such that the UE 120 may resume WUS occasion monitoring at a later time without receiving a reconfiguration from the base station 110). Enabling WUS occasion monitoring to be disabled by the base station 110 may conserve network resources that would have otherwise been used to transmit WUS during WUS occasions that are not monitored by the UE 120. Additionally, enabling WUS occasion monitoring to be disabled by the base station 110 may conserve UE resources (e.g., processing resources and/or power resources) that would have otherwise been used to identify the one or more conditions and/or to determine to disable WUS occasion monitoring.

As a result, the UE 120 may be enabled to conditionally monitor WUS occasions when wake-up signaling conserves power or energy consumed by the UE 120. If the wake-up signaling does not conserve power and/or consumes additional power or energy, the UE 120 may be able to disable WUS occasion monitoring (e.g., may be enabled to refrain from monitoring one or more, or all, WUS occasions configured by the base station 110). As a result, the UE 120 may improve an efficiency associated with power saving in connection with wake-up signaling. Therefore, the UE 120 may conserve power and/or energy associated with a DRX cycle when the UE 120 is configured to monitor WUS occasions associated with the DRX cycle by conditionally monitoring the WUS occasions, as described herein.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 120) performs operations associated with techniques for conditional WUS monitoring.

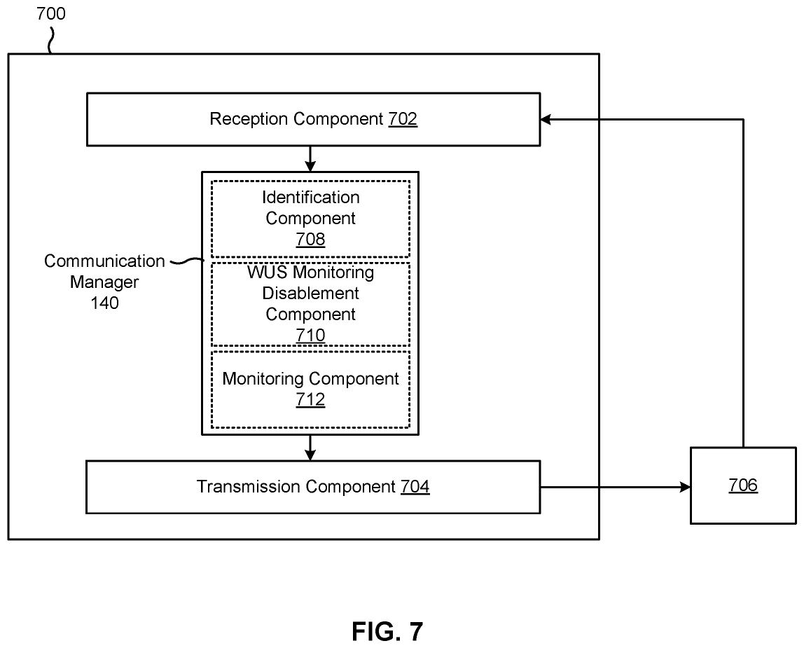

As shown in FIG. 6, in some aspects, process 600 may include receiving, from a network node, configuration information indicating a WUS configuration associated with a DRX cycle, wherein the WUS configuration indicates one or more WUS occasions (block 610). For example, the UE (e.g., using communication manager 140 and/or reception component 702, depicted in FIG. 7) may receive, from a network node, configuration information indicating a WUS configuration associated with a DRX cycle, wherein the WUS configuration indicates one or more WUS occasions, as described above.

As further shown in FIG. 6, in some aspects, process 600 may include identifying one or more conditions (block 620). For example, the UE (e.g., using communication manager 140 and/or identification component 708, depicted in FIG. 7) may identify one or more conditions, as described above.

As further shown in FIG. 6, in some aspects, process 600 may include refraining from monitoring at least one WUS occasion, from the one or more WUS occasions, based at least in part on the identification of the one or more conditions (block 630). For example, the UE (e.g., using communication manager 140 and/or WUS monitoring disablement component 710, depicted in FIG. 7) may refrain from monitoring at least one WUS occasion, from the one or more WUS occasions, based at least in part on the identification of the one or more conditions, as described above.

As further shown in FIG. 6, in some aspects, process 600 may include monitoring one or more resources during an on duration associated with the DRX cycle (block 640). For example, the UE (e.g., using communication manager 140 and/or monitoring component 712, depicted in FIG. 7) may monitor one or more resources during an on duration associated with the DRX cycle, as described above.

Process 600 may include additional aspects, such as any single aspect or any combination of aspects described below and/or in connection with one or more other processes described elsewhere herein.

In a first aspect, the on duration is a next on duration in a time domain after the at least one WUS occasion.

In a second aspect, alone or in combination with the first aspect, the one or more conditions are based at least in part on at least one of the WUS configuration, a search space set configuration, a minimum time gap, indicated by capability information associated with the UE, between on durations associated with the DRX cycle and WUS occasions, a time offset, indicated by the configuration information, between on durations associated with the DRX cycle and a first time that WUS occasions can occur, a duration of the one or more WUS occasions, or a PDCCH monitoring configuration.

In a third aspect, alone or in combination with one or more of the first and second aspects, identifying the one or more conditions includes identifying that a time offset satisfies a threshold, wherein the time offset is indicated by the configuration information, and wherein the time offset indicates an amount of time between an initiation of on durations associated with the DRX cycle and a first time that WUS occasions can occur.

In a fourth aspect, alone or in combination with one or more of the first through third aspects, identifying the one or more conditions includes identifying that a number of slots associated with the one or more WUS occasions satisfies a threshold.

In a fifth aspect, alone or in combination with one or more of the first through fourth aspects, the one or more conditions are based at least in part on one or more thresholds, and wherein the one or more thresholds are based at least in part on a scheduling rate of traffic activity associated with the UE.

In a sixth aspect, alone or in combination with one or more of the first through fifth aspects, process 600 includes receiving a CSI configuration, wherein the CSI configuration indicates one or more periodic CSI measurement and reporting configurations, and wherein the identification of the one or more conditions is based at least in part on the one or more periodic CSI measurement and reporting configurations.

In a seventh aspect, alone or in combination with one or more of the first through sixth aspects, identifying the one or more conditions includes identifying that at least one periodic CSI measurement and reporting parameters are configured, wherein the at least one periodic CSI measurement and reporting parameters indicates that a CSI measurement and reporting is to occur during on durations associated with the DRX cycle.

In an eighth aspect, alone or in combination with one or more of the first through seventh aspects, process 600 includes receiving a CSI configuration, wherein the CSI configuration indicates a timing associated with CSI measurement and reporting, wherein identifying the one or more conditions includes identifying that the timing indicates that CSI measurement and reporting is to occur during one or more on durations associated with the DRX cycle, and wherein refraining from monitoring the at least one WUS occasion includes refraining from monitoring each WUS occasion associated with the one or more on durations.

In a ninth aspect, alone or in combination with one or more of the first through eighth aspects, process 600 includes receiving a synchronization signal configuration, wherein the synchronization signal configuration indicates a timing associated with SSBs, wherein identifying the one or more conditions is based at least in part on the timing associated with the SSBs.

In a tenth aspect, alone or in combination with one or more of the first through ninth aspects, the identification of the one or more conditions is based at least in part on a number of on durations, associated with the DRX cycle, that are associated with receiving or transmitting traffic.

In an eleventh aspect, alone or in combination with one or more of the first through tenth aspects, identifying the one or more conditions includes identifying a percentage of served on durations associated with the DRX cycle, and determining that the percentage of served on durations satisfies a threshold.

In a twelfth aspect, alone or in combination with one or more of the first through eleventh aspects, the identification of the one or more conditions is based at least in part on a traffic type or a QoS flow associated with the UE.

In a thirteenth aspect, alone or in combination with one or more of the first through twelfth aspects, the identification of the one or more conditions is based at least in part on identifying that the UE is associated with VoNR traffic.

In a fourteenth aspect, alone or in combination with one or more of the first through thirteenth aspects, the identification of the one or more conditions is based at least in part on uplink statistics associated with the DRX cycle.

In a fifteenth aspect, alone or in combination with one or more of the first through fourteenth aspects, the identification of the one or more conditions is based at least in part on a frequency of scheduling requests or a percentage of active time, associated with the DRX cycle, that is associated with uplink traffic.

In a sixteenth aspect, alone or in combination with one or more of the first through fifteenth aspects, the identification of the one or more conditions is based at least in part on a number of activated component carriers.

In a seventeenth aspect, alone or in combination with one or more of the first through sixteenth aspects, the identification of the one or more conditions is based at least in part on a number of occurrences of false wake-ups associated with the DRX cycle.

In an eighteenth aspect, alone or in combination with one or more of the first through seventeenth aspects, process 600 includes identifying the number of occurrences of false wake-ups associated with the DRX cycle over a sliding time window, wherein a false wake-up is associated with monitoring an on duration based at least in part on receiving a WUS or failing to decode the WUS, and failing to receive any traffic during the on duration, wherein the identification of the one or more conditions is based at least in part on the number of occurrences of false wake-ups satisfying a threshold.

In a nineteenth aspect, alone or in combination with one or more of the first through eighteenth aspects, the identification of the one or more conditions is based at least in part on an energy consumption metric associated with monitoring the one or more WUS occasions in accordance with the configuration information.

In a twentieth aspect, alone or in combination with one or more of the first through nineteenth aspects, process 600 includes transmitting, to the network node, an indication to disable or de-configure the at least one WUS occasion.

In a twenty-first aspect, alone or in combination with one or more of the first through twentieth aspects, process 600 includes receiving, from the network node, an indication to refrain from monitoring the at least one WUS occasion, wherein the identification of the one or more conditions is based at least in part on the reception of the indication.

In a twenty-second aspect, alone or in combination with one or more of the first through twenty-first aspects, refraining from monitoring the at least one WUS occasion includes refraining from monitoring a downlink channel for a WUS during the at least one WUS occasion.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, a network node, a network entity, or another wireless communication device) using the reception component 702 and the transmission component 704. As further shown, the apparatus 700 may include the communication manager 140. The communication manager 140 may include one or more of an identification component 708, a WUS monitoring disablement component 710, and/or a monitoring component 712, among other examples.

In some aspects, the apparatus 700 may be configured to perform one or more operations described herein in connection with FIG. 5. Additionally, or alternatively, the apparatus 700 may be configured to perform one or more processes described herein, such as process 600 of FIG. 6, or a combination thereof. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The reception component 702 may receive, from a network node, configuration information indicating a WUS configuration associated with a DRX cycle, wherein the WUS configuration indicates one or more WUS occasions. The identification component 708 may identify one or more conditions. The WUS monitoring disablement component 710 may refrain from monitoring at least one WUS occasion, from the one or more WUS occasions, based at least in part on the identification of the one or more conditions. The monitoring component 712 and/or the reception component 702 may monitor one or more resources during an on duration associated with the DRX cycle.

The reception component 702 may receive a CSI configuration, wherein the CSI configuration indicates one or more periodic CSI measurement and reporting configurations, and wherein the identification of the one or more conditions is based at least in part on the one or more periodic CSI measurement and reporting configurations.

The reception component 702 may receive a CSI configuration, wherein the CSI configuration indicates a timing associated with CSI measurement and reporting.

The reception component 702 may receive a synchronization signal configuration, wherein the synchronization signal configuration indicates a timing associated with SSBs, wherein identifying the one or more conditions is based at least in part on the timing associated with the SSBs.

The identification component 708 may identify the percentage of false wake-ups associated with the DRX cycle over a sliding time window, wherein a false wake-up is associated with monitoring an on duration based at least in part on receiving a WUS or failing to decode the WUS, and failing to receive any traffic during the on duration.

The transmission component 704 may transmit, to the network node, an indication to disable or de-configure the at least one WUS occasion.

The reception component 702 may receive, from the network node, an indication to refrain from monitoring the at least one WUS occasion, wherein the identification of the one or more conditions is based at least in part on the reception of the indication.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

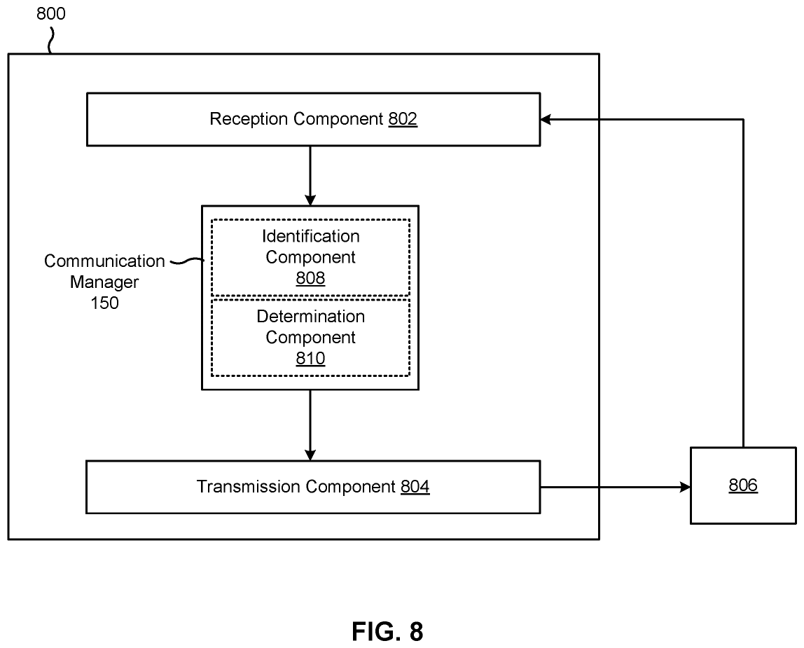

FIG. 8 is a diagram of an example apparatus 800 for wireless communication. The apparatus 800 may be a base station or a network node, or a base station or network node may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 150. The communication manager 150 may include one or more of an identification component 808 and/or a determination component 810, among other examples.

In some aspects, the apparatus 800 may be configured to perform one or more operations described herein in connection with FIG. 5. Additionally, or alternatively, the apparatus 800 may be configured to perform one or more processes described herein or a combination thereof. In some aspects, the apparatus 800 and/or one or more components shown in FIG. 8 may include one or more components of the base station described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the base station described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the base station described in connection with FIG. 2. In some aspects, the transmission component 804 may be co-located with the reception component 802 in a transceiver.

The transmission component 804 may receive, to a UE, configuration information indicating a WUS configuration associated with a DRX cycle, wherein the WUS configuration indicates one or more WUS occasions. The identification component 808 may identify one or more conditions. The transmission component 804 may transmit, to the UE, an indication to refrain from monitoring at least one WUS occasion, from the one or more WUS occasions, based at least in part on the identification of the one or more conditions.

The reception component 802 may receive, from the UE, an indication to disable or de-configure the at least one WUS occasion. The determination component 810 may determine an updated WUS configuration for the UE based at least in part on the reception of the indication to disable or de-configure the at least one WUS occasion.

The transmission component 804 may transmit, to the UE, an indication to refrain from monitoring the at least one WUS occasion to cause the UE to refrain from monitoring the at least one WUS occasion.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: receiving, from a network node, configuration information indicating a wake-up signal (WUS) configuration associated with a discontinuous reception (DRX) cycle, wherein the WUS configuration indicates one or more WUS occasions; identifying one or more conditions; refraining from monitoring at least one WUS occasion, from the one or more WUS occasions, based at least in part on the identification of the one or more conditions; and monitoring one or more resources during an on duration associated with the DRX cycle.

Aspect 2: The method of Aspect 1, wherein the on duration is a next on duration in a time domain after the at least one WUS occasion.

Aspect 3: The method of any of Aspects 1-2, wherein the one or more conditions are based at least in part on at least one of: the WUS configuration; a search space set configuration; a minimum time gap, indicated by capability information associated with the UE, between on durations associated with the DRX cycle and WUS occasions; a time offset, indicated by the configuration information, between on durations associated with the DRX cycle and a first time that WUS occasions can occur; a duration of the one or more WUS occasions; or a physical downlink control channel (PDCCH) monitoring configuration.

Aspect 4: The method of any of Aspects 1-3, wherein identifying the one or more conditions comprises: identifying that a time offset satisfies a threshold, wherein the time offset is indicated by the configuration information, and wherein the time offset indicates an amount of time between an initiation of on durations associated with the DRX cycle and a first time that WUS occasions can occur.

Aspect 5: The method of any of Aspects 1-4, wherein identifying the one or more conditions comprises: identifying that a number of slots associated with the one or more WUS occasions satisfies a threshold.

Aspect 6: The method of any of Aspects 1-5, wherein the one or more conditions are based at least in part on one or more thresholds, and wherein the one or more thresholds are based at least in part on a scheduling rate of traffic activity associated with the UE.

Aspect 7: The method of any of Aspects 1-6, further comprising: receiving a channel state information (CSI) configuration, wherein the CSI configuration indicates one or more periodic CSI measurement and reporting configurations, and wherein the identification of the one or more conditions is based at least in part on the one or more periodic CSI measurement and reporting configurations.

Aspect 8: The method of any of Aspects 1-7, wherein identifying the one or more conditions comprises: identifying that at least one periodic channel state information (CSI) measurement and reporting parameters are configured, wherein the at least one periodic CSI measurement and reporting parameters indicates that a CSI measurement and reporting is to occur during on durations associated with the DRX cycle.

Aspect 9: The method of any of Aspects 1-8, further comprising: receiving a channel state information (CSI) configuration, wherein the CSI configuration indicates a timing associated with CSI measurement and reporting; wherein identifying the one or more conditions comprises identifying that the timing indicates that CSI measurement and reporting is to occur during one or more on durations associated with the DRX cycle; and wherein refraining from monitoring the at least one WUS occasion comprises refraining from monitoring each WUS occasion associated with the one or more on durations.

Aspect 10: The method of any of Aspects 1-9, further comprising: receiving a synchronization signal configuration, wherein the synchronization signal configuration indicates a timing associated with synchronization signal blocks (SSBs), wherein identifying the one or more conditions is based at least in part on the timing associated with the SSBs.

Aspect 11: The method of any of Aspects 1-10, wherein the identification of the one or more conditions is based at least in part on a number of on durations, associated with the DRX cycle, that are associated with receiving or transmitting traffic.

Aspect 12: The method of any of Aspects 1-11, wherein identifying the one or more conditions comprises: identifying a percentage of served on durations associated with the DRX cycle; and determining that the percentage of served on durations satisfies a threshold.

Aspect 13: The method of any of Aspects 1-12, wherein the identification of the one or more conditions is based at least in part on a traffic type or a quality of service (QOS) flow associated with the UE.

Aspect 14: The method of any of Aspects 1-13, wherein the identification of the one or more conditions is based at least in part on identifying that the UE is associated with voice over New Radio (VoNR) traffic.

Aspect 15: The method of any of Aspects 1-14, wherein the identification of the one or more conditions is based at least in part on uplink statistics associated with the DRX cycle.

Aspect 16: The method of any of Aspects 1-15, wherein the identification of the one or more conditions is based at least in part on a frequency of scheduling requests or a percentage of active time, associated with the DRX cycle, that is associated with uplink traffic.

Aspect 17: The method of any of Aspects 1-16, wherein the identification of the one or more conditions is based at least in part on a number of activated component carriers.

Aspect 18: The method of any of Aspects 1-17, wherein the identification of the one or more conditions is based at least in part on a number of occurrences of false wake-ups associated with the DRX cycle.

Aspect 19: The method of Aspect 18, further comprising: identifying the number of occurrences of false wake-ups associated with the DRX cycle over a sliding time window, wherein a false wake-up is associated with monitoring an on duration based at least in part on: receiving a WUS or failing to decode the WUS, and failing to receive any traffic during the on duration, and wherein the identification of the one or more conditions is based at least in part on the number of occurrences of false wake-ups satisfying a threshold. wherein the identification of the one or more conditions is based at least in part on the number of occurrences of false wake-ups satisfying a threshold.

Aspect 20: The method of any of Aspects 1-19, wherein the identification of the one or more conditions is based at least in part on an energy consumption metric associated with monitoring the one or more WUS occasions in accordance with the configuration information.

Aspect 21: The method of any of Aspects 1-20, further comprising: transmitting, to the network node, an indication to disable or de-configure the at least one WUS occasion.

Aspect 22: The method of any of Aspects 1-21, further comprising: receiving, from the network node, an indication to refrain from monitoring the at least one WUS occasion, wherein the identification of the one or more conditions is based at least in part on the reception of the indication.

Aspect 23: The method of any of Aspects 1-22, wherein refraining from monitoring the at least one WUS occasion comprises: refraining from monitoring a downlink channel for a WUS during the at least one WUS occasion.

Aspect 24: An apparatus for wireless communication at a device, comprising a processor; memory coupled with the processor; and instructions stored in the memory and executable by the processor to cause the apparatus to perform the method of one or more of Aspects 1-23.

Aspect 25: A device for wireless communication, comprising a memory and one or more processors coupled to the memory, the one or more processors configured to perform the method of one or more of Aspects 1-23.

Aspect 26: An apparatus for wireless communication, comprising at least one means for performing the method of one or more of Aspects 1-23.

Aspect 27: A non-transitory computer-readable medium storing code for wireless communication, the code comprising instructions executable by a processor to perform the method of one or more of Aspects 1-23.

Aspect 28: A non-transitory computer-readable medium storing a set of instructions for wireless communication, the set of instructions comprising one or more instructions that, when executed by one or more processors of a device, cause the device to perform the method of one or more of Aspects 1-23.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code-it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving, from a network node, configuration information indicating a wake-up signal (WUS) configuration associated with a discontinuous reception (DRX) cycle, wherein the WUS configuration indicates one or more WUS occasions;
identifying one or more conditions;
refraining from monitoring at least one WUS occasion, from the one or more WUS occasions, based at least in part on the identification of the one or more conditions; and
monitoring one or more resources during an on duration associated with the DRX cycle.

2. The method of claim 1, wherein the on duration is a next on duration in a time domain after the at least one WUS occasion.

3. The method of claim 1, wherein the one or more conditions are based at least in part on at least one of:
the WUS configuration;
a search space set configuration;
a minimum time gap, indicated by capability information associated with the UE, between on durations associated with the DRX cycle and WUS occasions;
a time offset, indicated by the configuration information, between on durations associated with the DRX cycle and a first time that WUS occasions can occur;
a duration of the one or more WUS occasions; or
a physical downlink control channel (PDCCH) monitoring configuration.

4. The method of claim 1, wherein the identification of the one or more conditions comprises:
identifying that a time offset satisfies a threshold, wherein the time offset is indicated by the configuration information, and wherein the time offset indicates an amount of time between an initiation of on durations associated with the DRX cycle and a first time that WUS occasions can occur.

5. The method of claim 1, wherein the identification of the one or more conditions comprises:
identifying that a number of slots associated with the one or more WUS occasions satisfies a threshold.

6. The method of claim 1, wherein the one or more conditions are based at least in part on one or more thresholds, and wherein the one or more thresholds are based at least in part on a scheduling rate of traffic activity associated with the UE.

7. The method of claim 1, further comprising:
receiving a channel state information (CSI) configuration, wherein the CSI configuration indicates one or more periodic CSI measurement and reporting configurations, and wherein the identification of the one or more conditions is based at least in part on the one or more periodic CSI measurement and reporting configurations.

8. The method of claim 1, further comprising:
receiving a channel state information (CSI) configuration, wherein the CSI configuration indicates a timing associated with CSI measurement and reporting;
wherein the identification of the one or more conditions comprises identifying that the timing indicates that CSI measurement and reporting is to occur during one or more on durations associated with the DRX cycle; and
wherein refraining from monitoring the at least one WUS occasion comprises refraining from monitoring each WUS occasion associated with the one or more on durations.

9. The method of claim 1, further comprising:
receiving a synchronization signal configuration, wherein the synchronization signal configuration indicates a timing associated with synchronization signal blocks (SSBs), wherein identifying the one or more conditions is based at least in part on the timing associated with the SSBs.

10. The method of claim 1, wherein the identification of the one or more conditions is based at least in part on a number of on durations, associated with the DRX cycle, that are associated with receiving or transmitting traffic.

11. The method of claim 1, wherein the identification of the one or more conditions comprises:
identifying a percentage of served on durations associated with the DRX cycle; and
determining that the percentage of served on durations satisfies a threshold.

12. The method of claim 1, wherein the identification of the one or more conditions is based at least in part on identifying that the UE is associated with voice over New Radio (VoNR) traffic.

13. The method of claim 1, wherein the identification of the one or more conditions is based at least in part on a number of occurrences of false wake-ups associated with the DRX cycle.

14. The method of claim 13, further comprising:
identifying the number of occurrences of false wake-ups associated with the DRX cycle over a sliding time window, wherein a false wake-up is associated with monitoring an on duration based at least in part on:
receiving a WUS or failing to decode the WUS, and
failing to receive any traffic during the on duration, and
wherein the identification of the one or more conditions is based at least in part on the number of occurrences of false wake-ups satisfying a threshold.

15. A user equipment (UE) for wireless communication, comprising:
a memory; and
one or more processors, coupled to the memory, configured to:
receive, from a network node, configuration information indicating a wake-up signal (WUS) configuration associated with a discontinuous reception (DRX) cycle, wherein the WUS configuration indicates one or more WUS occasions;
identify one or more conditions;
refrain from monitoring at least one WUS occasion, from the one or more WUS occasions, based at least in part on the identification of the one or more conditions; and
monitor one or more resources during an on duration associated with the DRX cycle.

16. The UE of claim 15, wherein the one or more conditions are based at least in part on at least one of:
the WUS configuration;
a search space set configuration;
a minimum time gap, indicated by capability information associated with the UE, between on durations associated with the DRX cycle and WUS occasions;
a time offset, indicated by the configuration information, between on durations associated with the DRX cycle and a first time that WUS occasions can occur;
a duration of the one or more WUS occasions; or
a physical downlink control channel (PDCCH) monitoring configuration.

17. The UE of claim 15, wherein the one or more processors, to identify the one or more conditions, are configured to:
identify that a time offset satisfies a threshold, wherein the time offset is indicated by the configuration information, and wherein the time offset indicates an amount of time between an initiation of on durations associated with the DRX cycle and a first time that WUS occasions can occur.

18. The UE of claim 15, wherein the one or more conditions are based at least in part on one or more thresholds, and wherein the one or more thresholds are based at least in part on a scheduling rate of traffic activity associated with the UE.

19. The UE of claim 15, wherein the one or more processors, to identify the one or more conditions, are configured to:
identify that at least one periodic channel state information (CSI) measurement and reporting parameters are configured, wherein the at least one periodic CSI measurement and reporting parameters indicates that a CSI measurement and reporting is to occur during on durations associated with the DRX cycle.

20. The UE of claim 15, wherein the one or more processors are further configured to:
receive a channel state information (CSI) configuration, wherein the CSI configuration indicates a timing associated with CSI measurement and reporting;
wherein the one or more processors, to identify the one or more conditions, are configured to identify that the timing indicates that CSI measurement and reporting is to occur during one or more on durations associated with the DRX cycle; and
wherein the one or more processors, to refrain from monitoring the at least one WUS occasion, are configured to refrain from monitoring each WUS occasion associated with the one or more on durations.

21. The UE of claim 15, wherein the identification of the one or more conditions is based at least in part on a number of on durations, associated with the DRX cycle, that are associated with receiving or transmitting traffic.

22. The UE of claim 15, wherein the identification of the one or more conditions is based at least in part on a traffic type or a quality of service (QOS) flow associated with the UE.

23. The UE of claim 15, wherein the identification of the one or more conditions is based at least in part on uplink statistics associated with the DRX cycle.

24. The UE of claim 15, wherein the identification of the one or more conditions is based at least in part on a number of activated component carriers.

25. The UE of claim 15, wherein the identification of the one or more conditions is based at least in part on a number of occurrences of false wake-ups associated with the DRX cycle.

26. The UE of claim 25, wherein the one or more processors are further configured to:
identify the number of occurrences of false wake-ups associated with the DRX cycle over a sliding time window, wherein a false wake-up is associated with monitoring an on duration based at least in part on:
receiving a WUS or failing to decode the WUS, and
failing to receive any traffic during the on duration, and
wherein the identification of the one or more conditions is based at least in part on the number of occurrences of false wake-ups satisfying a threshold.

27. The UE of claim 15, wherein the one or more processors are further configured to:
transmit, to the network node, an indication to disable or de-configure the at least one WUS occasion.

28. The UE of claim 15, wherein the one or more processors are further configured to:
receive, from the network node, an indication to refrain from monitoring the at least one WUS occasion, wherein the identification of the one or more conditions is based at least in part on the reception of the indication.

29. A non-transitory computer-readable medium storing a set of instructions for wireless communication, the set of instructions comprising:
one or more instructions that, when executed by one or more processors of a user equipment (UE), cause the UE to:
receive, from a network node, configuration information indicating a wake-up signal (WUS) configuration associated with a discontinuous reception (DRX) cycle, wherein the WUS configuration indicates one or more WUS occasions;
identify one or more conditions;
refrain from monitoring at least one WUS occasion, from the one or more WUS occasions, based at least in part on the identification of the one or more conditions; and
monitor one or more resources during an on duration associated with the DRX cycle.

30. An apparatus for wireless communication, comprising:
means for receiving, from a network node, configuration information indicating a wake-up signal (WUS) configuration associated with a discontinuous reception (DRX) cycle, wherein the WUS configuration indicates one or more WUS occasions;
means for identifying one or more conditions;
means for refraining from monitoring at least one WUS occasion, from the one or more WUS occasions, based at least in part on the identification of the one or more conditions; and
means for monitoring one or more resources during an on duration associated with the DRX cycle.
